(19) United States
(12) Patent Application Publication
(10) Pub. No.: US 2026/0310424 A1
(43) Pub. Date: Oct. 8, 2026

(54) SOFTWARE PRODUCT MODEL GENERATION

(71) Applicant: Government Employees Insurance Company (GEICO), Fredericksburg, VA (US)

(72) Inventors: Atul CHHODA, Fairfax, VA (US); Alok VARIA, Plainsboro, NJ (US); Bryan WATSON, Noblesville, IN (US); Senthil SEKAR, Gaithersburg, MD (US); Naga Balaji KUKUNURI, Aldie, VA (US); Mohammed Rafi KALEEM, Longwood, FL (US); Avinash Reddy MUTHYALA, Dumfries, VA (US); Mansi KAMDAR, Ashburn, VA (US); James KELLER, Washington, DC (US)

(21) Appl. No.: 19/098,875

(22) Filed: Apr. 2, 2025

(51) Int. Cl. G06F 8/35

(52) U.S. Cl. CPC G06F 8/35

(57) ABSTRACT

Disclosed herein are system, method, and computer program product embodiments for generating a software product model. An embodiment operates by receiving a user input comprising one or more rules represented in a domain specific language. The one or more rules may belong to a set of rules for generating software product models. The set of rules may comprise a plurality of data transformations. Data dependencies may be identified among the plurality of data transformations. Values associated with a set of data dependencies of a data transformation of the plurality of data transformations may be monitored. In response to detecting a change in a value of the values associated with the set of data dependencies, the data transformation may be refined by reevaluating the data transformation. Executable code for the software product model may be generated. The executable code for the software product model may be stored as immutable.

### BACKGROUND

Many commercial enterprises, financial institutions, and insurance companies offer multiple products that may vary based on multiple factors such as a location of a customer and regulations. In addition, companies may modify an existing product. For example, the company may modify the existing product when one or more factors associated with the product change. For example, an insurance company may modify an insurance product when a new vehicle type is released on the market. In addition, the insurance product may be modified when new regulations are passed. For example, some jurisdictions may change the minimum coverage associated with a vehicle insurance policy and a type of coverage (e.g., bodily injury liability and/or property damage liability).

### SUMMARY

Provided herein are system, apparatus, device, method, and/or computer program product embodiments, and/or combinations and sub-combinations thereof, for generating software product models. A user input comprising one or more rules represented in a domain specific language may be received at a product management platform. The one or more rules may belong to a set of rules for generating software product models. The set of rules may comprise a plurality of data transformations. Data dependencies may be identified among the plurality of data transformations by the product management platform. Values associated with a set of data dependencies of a data transformation of the plurality of data transformations may be monitored by the product management platform. In response to detecting a change in a value of the values associated with the set of data dependencies, the data transformation may be refined by reevaluating the data transformation. Executable code for the software product model may be generated, by the product management platform, based on the user input and the refined data transformation. The executable code for the software product model may be stored as immutable,

### BRIEF DESCRIPTION OF THE DRAWINGS The accompanying drawings are incorporated herein and form a part of the specification.

FIG. 1 illustrates an example environment for generating a software product model, according to some embodiments.

FIG. 2 illustrates a flow diagram for software product model generation and publishing, according to some embodiments.

FIG. 3 illustrates components of a software product model, according to some embodiments.

FIG. 4 illustrates an example environment for code generation, according to some embodiments.

FIG. 5 illustrates an example environment for software product model retrieval, according to some embodiments.

FIG. 6 illustrates a flow chart for an example method for generating a software product model, according to some embodiments.

FIG. 7 illustrates an example computer system for implementing various embodiments.

In the drawings, like reference numbers generally indicate identical or similar elements. Additionally, generally, the left-most digit(s) of a reference number identifies the figure in which the reference number first appears.

### DETAILED DESCRIPTION

Provided herein are system, apparatus, device, method and/or computer program product embodiments, and/or combinations and sub-combinations thereof, for generating software product models. Using the embodiments described herein, users may efficiently generate software product models (e.g., an insurance product). Software product models are generated more accurately while memory usage is reduced and processing power is conserved.

In accordance with aspects described herein, a software product model may be generated (e.g., created and configured). The software product model may be a software representation of a product associated with an entity, such as a business, an organization, or the like. For instance, the software product model may model a product, such as an insurance product provided by an insurance company, a financial product provided by a financial institution, or the like. In some cases, the entity may need to generate a new software product model or modify an existing software product model when factors associated with the underlying product (e.g., the insurance product, the financial product, etc.) change. For instance, an insurance company may modify or create a new software product model when state insurance regulations or guidelines change (e.g., a state may revise a minimum coverage amount required for property damage for vehicle insurance) for an insurance product; or a financial institution may modify or create a new software product model when a deposit requirement changes for a bank account product. In some cases, an entity may wish to maintain multiple software product model versions for similar software product models. For instance, the entity may maintain different software product model versions associated with a vehicle insurance product for different jurisdictions (e.g., differ states); or different software product model versions associated with a financial product for different deposit amounts. Accordingly, the different versions of such software product models may be similar except that they may be associated with different business rules or different parameters to support the differences in the underlying products. In accordance with aspects described herein, a system may be provided to support the generation and management of such software product models and versions.

Generating software product models may involve one or more rules (e.g., business rules or other types of rules) that may include one or more data transformations, one or more refinements, or both. A refinement may refer to a rule (e.g., a business rule or other type of rule) that includes one or more data transformations. Data transformations may involve values (e.g., factors) that may change or vary (e.g., based on user inputs or other events) over time. The technological field of data transformation suffers from a lack of accuracy. Before using a value obtained from the data transformation, the data transformations often need to be executed multiple times. That is, all the data transformations and/or refinements have to be evaluated to confirm that each data transformation is outputting the correct values. However, the refinement may involve a large number of data transformations. Revaluating all the data transformations to ensure accuracy causes memory and processing challenges.

In some embodiments, data transformation may operate on one or more data tables. The data tables may include multiple rows. This poses the technical challenge of long loading times to memory (e.g., loading the one or more data tables into memory) and an increased memory usage requirement, which may cause time out errors when generating a new software product model.

Embodiments described herein may address some or all of the foregoing technical issues that relate to generating software product models. By identifying data dependencies associated with the data transformations, the embodiments described herein solve the problem of memory usage and processing challenges while maintaining the data accuracy when performing data transformations. By reevaluating the data transformations that depend on data that has changed, without reevaluating data transformations that are not dependent on the data that has changed, processing of the data transformation can be performed faster. Data transformations that are not affected by the change are not reevaluated, thus processing power is conserved. In addition, because the data dependencies are identified, after the data transformation is reevaluated its value may be used to reevaluate other refinements and data transformations that are associated with the reevaluated data transformation.

By selectively loading columns data from data tables to the memory, embodiments described herein solve the technical challenges associated with memory usage requirements for processing data tables, by reducing such memory usage requirements. In addition, the cost (e.g., data transfer time) of the data transformation is reduced. Further, embodiments described herein solve the technical challenge of maintaining data integrity when generating and modifying existing software product models. The integrity of the generated software product models is preserved by storing, as immutable, executable code for the software product models. In addition, by embedding data tables and/or other characteristics used when generating the software product models with the executable code, the software product models become immutable.

Using the embodiments described herein, improvements to processing times, data accuracy, and compliance (e.g., with regulation) may be achieved during creation, configuration, and deployment of a software product model.

The platform disclosed herein may be accessed by users (e.g., business owners) for generating new software product models or revising existing software product models. The platform may support defining data elements associated with the software product models, acquiring data from various data sources, transforming data (e.g., according to business logic or rules), and validating data or business logic/rules. The software product models may be configurable, such as to support different lines of business (LOB) (e.g., vehicle insurance, home insurance, etc.), different states, different data elements or characteristics, etc. As such, the platform may support versioning of the software product models. In some examples, the different software product models may be associated with different business logic or rules. The business logic/rules may comprise underwriting rules, risk determinations, rate calculations, or a combination thereof. In some examples, the business logic/rules may be represented using a low code style (e.g., JavaScript Object Notation (JSON)) and may be referred to as product artifacts. Using the low code style provides the advantage of accessing and modifying the business logic/rules without intervention by developers. Using the platform, an immutable version of the software product model may be deployed to an environment, such as a production environment (e.g., for availability to provide insurance quotes to customers). Thus, the platform may enable new or revised software product models to be generated faster, while reducing the risk of lack of compliance with associated regulations, guidelines, or the like.

After generating the software product models, the software product model may be deployed. After the software product model is deployed, the software product model may be used by the business, such as for quotations. Conventionally, software product models are deployed sequentially using a single pipeline, as triggering multiple pipelines for each state, LOB, etc. may be impractical and difficult to maintain. Limited agent pools may constrain an ability for conventional systems to use multiple pipelines to deploy bulk software product models, leading to deployment issues. For example, sequential deployment of a large number of software product models may take a significant amount of time for conventional systems to perform (e.g., sequentially deploying 700 software product models may take about four hours), making the process inefficient. In some instances, the deployment times may exceed a timeout associated with pipelines used for deployment of the software product model. The technological solution in the present disclosure can provide bulk deployments of software product models, enabling improved response times (e.g., less than 10 ms of latency).

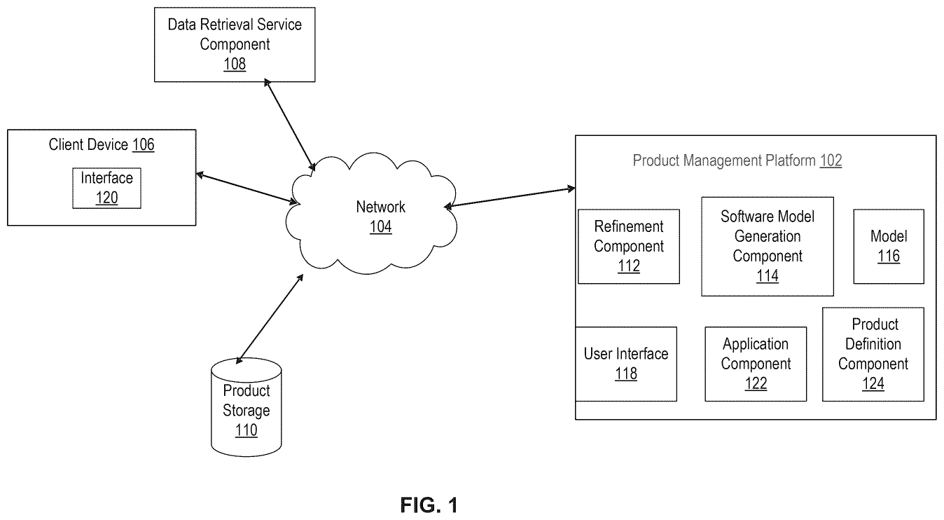

FIG. 1 illustrates an example environment 100 for generating a software product model, according to some embodiments. Environment 100 is provided for the purpose of illustration only and does not limit the disclosed embodiments.

Environment 100 may comprise a product management platform 102, a network 104, a client device 106, a data retrieval service component 108, and a product storage 110.

In some embodiments, product management platform 102 may be implemented via one or more servers. The one or more servers may include various forms of servers including, but not limited to, a web server, an application server, a proxy server, a network server, and/or a server pool. In general, server systems may accept requests for application services and provide such services to any number of client devices (e.g., the client device 106) over network 104. In some embodiments, product management platform 102 may be scalable based on demand (e.g., a quantity of requests received).

Product management platform 102 may comprise one or more components, such as a refinement component 112, a software module generation component 114, a model 116, a user interface 118, an application component 122, and a product definition component 124. In some implementations, the product management platform 102 may have additional or different components. The one or more components of the product management platform 102 are illustrated as separate components, however, in some examples, any combination of these components may be implemented as a single component.

The user interface (UI) 118 may allow a user to interact with product management platform 102 using client device 106. In one embodiment, the UI 118 may be a JSON based UI. However, in other embodiments, the UI 118 may be implemented using other formats. Product management platform 102 may receive, via the UI 118, inputs to manage and create a software product model In some embodiments, product definition component 124 may receive the input via the UI 118. The input may indicate a new software product model definition or a change to an existing software product model definition.

In some embodiments, the software product model may be an insurance product. Product management platform 102 may be configured to generate a product entity and characteristic definition for the software product model. Product management platform 102 may generate the software product model using product artifacts and model abstractions. For instance, the software product model may refer to an assembly of artifacts from a specific set of artifacts identified from a model 116 that may be used to define a software product model, such as the product entities and characteristics used by the software product model for rating and other product definition-centric services. Model 116 may also include model abstractions that refer to aspects of software product model generation that are not configurable.

In some embodiments, rules associated with the generation of software product models may be expressed using an expression language. In some embodiments, the expression language may be a domain specific language (DSL). The syntax of the DSL may be configured such that users may code, validate, and maintain the software product model in a user-friendly format close to a spreadsheet style of writing expressions. Complex operations associated with the generation of the software product model may be expressed more succinctly and accurately. In some embodiments, model 116 may include a set of rules. Model 116 may be designed to handle recursive usability of one or more rules. The user input may include one or more rules of the set of rules.

In one embodiment, the user input may be parsed using Another Tool for Language Recognition (ANTLR). However, in other embodiments, other parsers may be used to parse the DSL expression.

In some embodiments, the software model product may be generated based on a received user input that comprises one or more rules expressed in DSL. The DSL may be transformed into code. In an embodiment, the DSLs may be transformed to C code. In another embodiment, the DSLs may be transformed to C #code. However, in other embodiments, other languages may be used. Then, the code may be transformed to a binary code. The software product model may be deployed into a runtime environment of a microservice.

Product management platform 102 may comprise a refinement component 112 and a software model generation component 114. Refinement component 112 may handle DSL expressions. DSL expressions may define how the data is to be transformed and validated. Data transformations may support multiple ways for transforming the data, such as calculation, ranking, switch cases, formulas, table query, etc. Software model generation component 114 may generate code associated with the software product model. Data transformations and/or validation expressions, received in DSL by software model generation component 114 from refinement component 112, may be parsed into machine-readable format and processed by software model generation component 114.

In some embodiments, a plurality of data elements may be associated with the data transformations. The data elements may be a function of one or more inputs. The inputs may include user inputs and data fetched from external or internal sources (e.g., via data retrieval service component 108) as described further below. Refinement component 112 may determine a value of a data element based on the one or more inputs. In some embodiments, refinement component 112 may execute an expression to obtain the value of the data elements based on the inputs. Each data element may be referred to as a characteristic. A refined characteristic may refer to characteristics calculated or transformed from raw data, external data sources, or both. In some embodiments, the characteristics may be automatically refined as the raw data or external data entities are collected. In some embodiments, based on a request to create or configure a software product model, a plurality of data elements may be refined (e.g., using the data transformations).

In some embodiments, product management platform 102 may define features of software product models. Each feature may have multiple versions (e.g., each version may be associated with a different jurisdiction). A software product model may be generated by combining multiple features previously stored in model 116. Each feature may be tested before being merged into a software product model.

To ensure accuracy of data transformations associated with a user input, refinement component 112 may determine data dependencies between the plurality of data transformations. The data dependencies may be stored in refinement component 112. A data dependency between data transformations may refer to when an output of a data transformation is used as an input for a subsequent data transformation. Refinement component 112 may identify one or more data dependencies by parsing the data transformation to identify common variable names or function calls in the data transformation. Refinement component 112 may monitor values associated with the data dependencies of each data transformation of the plurality of data transformations. Refinement component 112 may detect a change in one or more values associated with the data dependencies. In response to detecting a change in one or more values associated with the data dependencies, refinement component 112 may refine the data transformation by revaluating the data transformation. For example, refinement component 112 may reevaluate each of the data transformations that are dependent on the value. In some embodiments, refinement component 112 may monitor the one or more values associated with the data dependencies by attaching (e.g., associating) an event listener to each data transformation of the plurality of data transformations. If the event listener detects a change in a value of the data dependencies, a signal may be sent to refinement component 112 to refine the data transformation. In some embodiments, when the event listener detects the change, an event handler may execute code to reevaluate the data transformation.

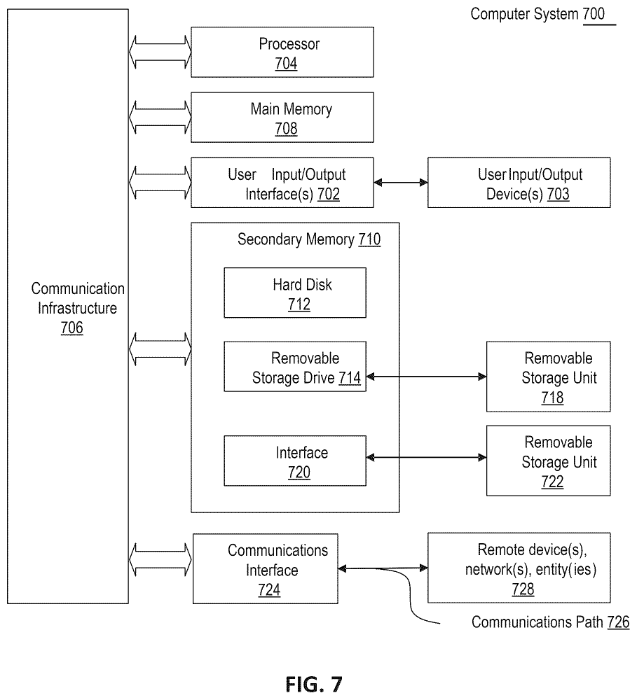

As discussed above, product management platform 102 may be implemented using one or more servers (e.g., computer system 700 as further described with reference to FIG. 7). Embodiments disclosed herein may improve the performance of a central processing unit (CPU) and a memory of the one or more servers of product management platform 102 by handling data transformations based on dependencies. In some embodiments, refinement component 112 may determine an order of refinement for the plurality of data transformations based on a quantity of data dependencies associated with each of the data transformations. In some embodiments, data transformations that have a lower quantity of dependencies have a higher order in the order of refinement and may be executed (e.g., refined) first. In some embodiments, refinement component 112 may execute the data transformations that have the same quantity of dependencies in parallel. This provides the advantage of reducing an amount of time to perform the data transformations and, additionally, reducing CPU requirements.

As described above, data transformations may include multiple ways of transforming the data, such as by calculations, rankings, switch cases, formulas, and table queries. For example, a data transformation that comprises a table query may load a file (e.g., a data table) associated with a query into memory. Then, refinement component 112 may execute the data transformations using the loaded data table by evaluating the rows in the data table. In some embodiments, refinement component 112 may analyze the data transformation and may identify one or more data columns on which the data transformation (e.g., a table query) is dependent. Refinement component 112 may load the data associated with the identified columns to memory as an alternative to loading all the columns of the data table to memory. In one example, a DSL expression representing a data transformation that involves a table query may have the name of the data columns in square brackets, such as “[Column name].” Refinement component 112 may identify the column name by detecting the square bracket in the DSL expression. This provides the advantage of improving performance and operation of the one or more servers associated with product management platform 102 by reducing the memory requirements.

In some embodiments, refinement component 112 may preprocess data associated with some types of data transformations. For instance, in some embodiments, refinement component 112 may hash data that satisfies a data transformation. For example, if the data transformation involves identifying a one-to-one match (e.g., A==A or B==B), refinement component 112 may identify values in a data table that satisfy the data transformation. Then, refinement component 112 may apply a hash to the identified values. The result of the hash may be stored in the memory. Additionally, by hashing inputs to locate values that satisfy the data transformation (rather than searching an entire data table to locate matching values), a technological improvement may be achieved by reducing an amount of time and CPU usage to identify the values that satisfy the data transformation. Refinement component 112 may operate on the result of the hash (e.g., a hash index) to identify the values instead of loading and analyzing all the rows of the data table to find the matching value. For example, refinement component 112 may look through the hash values stored in the memory to find a hash value for the data transformation and then obtain the inputs. Then, from the identified hash value, the corresponding inputs (e.g., one or more rows) may be determined. In some embodiments, the data transformation may include a table query with multiple parts. If the data transformation is looking for a range of data and a one-to-one match, e.g., A>B and A===A, the refinement component 112 may hash all the one-to-one evaluation values that satisfy the one-to-one match (e.g., A==A). Then, refinement component 112 may execute the range evaluation (e.g., A>B) within the hash. This reduces an amount of time and CPU required since refinement component 112 may iterate on the rows of data that satisfy the one-to-one match.

As discussed above, product management platform 102 may receive, from client device 106, a user input that includes DSL expressions. The DSL expressions may include one or more data transformations from model 116. In some embodiments, based on a DSL expression comprising a data transformation being received, product management platform 102 may load the data associated with the data transformation into memory (e.g., loading a data table when the data transformation involves a table query) when the data is not currently in the memory. In some instances, loading the data may exceed a predefined time period and may cause errors (e.g., timeouts). Product management platform 102 provides a technological solution by loading raw data tables into memory when an indexed data table is created. Then, the data transformation may operate on the cached version of the raw data table. After the data tables have been loaded in memory, product management platform 102 may load the remaining data transformations tables that use the raw data tables. A raw data table may refer to a data table in its original form that includes all columns and rows. An indexed data table may refer to one or more tables that include a subset of the raw data table. The subset may include the one or more columns used by the data transformation. After the data tables are loaded into memory, the cached raw data tables may be deleted. This provides the advantage of reduced processing time and CPU usage.

Product storage 110 may represent one or more data stores that store various software product models generated by the product management platform 102. In some embodiments, product storage 110 may store data used by the product management platform 102 to generate the software product model. In some embodiments, product storage 110 may store immutable copies of the generated software product models. In some embodiments, product management platform 102 may embed data used in the DSL expression into the generated software product model. For example, data tables used by the DSL expression may be embedded into the generated software product model. As discussed above, in one embodiment, the generated software product model may be stored as binary code (e.g., . net assembly).

In some embodiments, product management platform 102 may track and compare versions of the generated software product models and/or features that may be assembled into a software product model. In one embodiment, the product management platform 102 may use GIT® tags to control the versions. However, in other embodiments, other techniques may be used.

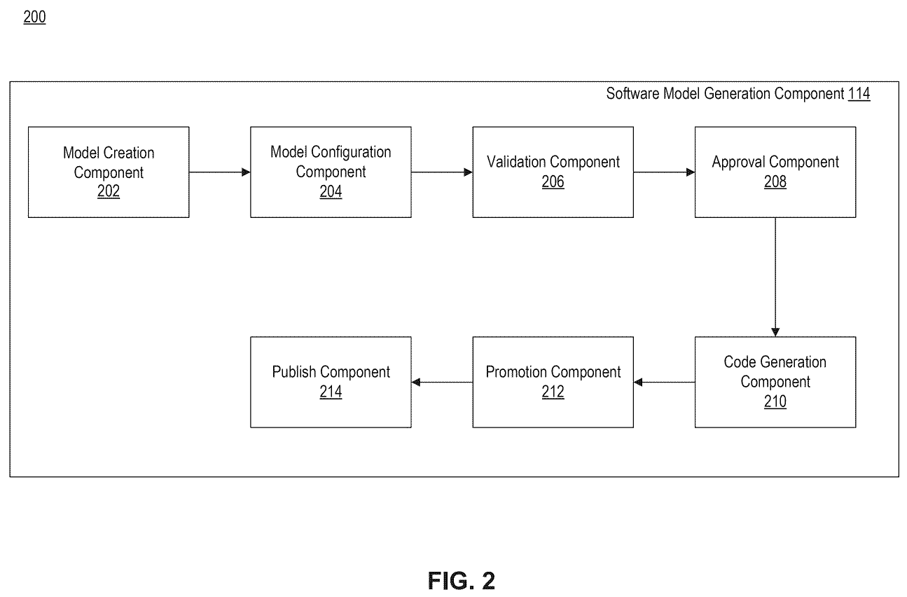

Client device 106 may represent one or more client devices that interact with the product management platform 102, such as via UI 118, to generate, maintain, and validate products. Client device 106 may also connect with product storage 110 to retrieve one or more software product models. Client device 106 may retrieve the software product model using a product identification. Client device 106 may access product storage 110 via a publish component as further described in relation with FIG. 2.

Client device 106 may comprise an interface 120 for presenting and/or receiving information to/from a user. Interface 120 may be a communication interface such as a command window, a web browser, a display, and/or any other type of interface. Other software, hardware, and/or interfaces may be used to provide communication between the user and product management platform 102. For example, interface 120 may be a web portal that provides a web page or website for viewing and interaction. The web portal may be located at a web address accessible via a web browser, and may be supported by one or more servers (e.g., computer system 700 as further described with reference to FIG. 7). The website may be a graphical UI (GUI) provided by product management platform 102 or via an application programing interface (API) provided by product management platform 102.

As used herein, the API may comprise any software capable of performing an interaction between one or more software components as well as interacting with and/or accessing one or more data storage elements (e.g., server systems, databases, hard drives, and the like). The API may comprise a library that specifies routines, data structures, object classes, variables, and the like. Thus, the API may be formulated in a variety of ways and based upon a variety of specifications or standards, including but not limited to, for example, POSIX, the MICROSOFT WINDOWS API®, a standard library such as C++, a JAVA API, and the like.

In some embodiments, client device 106 may interact with product management platform 102 to manage, create, or configure a software product model, such as an insurance product, a structure, or a cost associated with the software product model. Client device 106 may communicate with product management platform 102 over the network 104. In some examples, client device 106 may include any appropriate type of computing device such as a server, a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, or an appropriate combination of any two or more of these devices or other data processing devices.

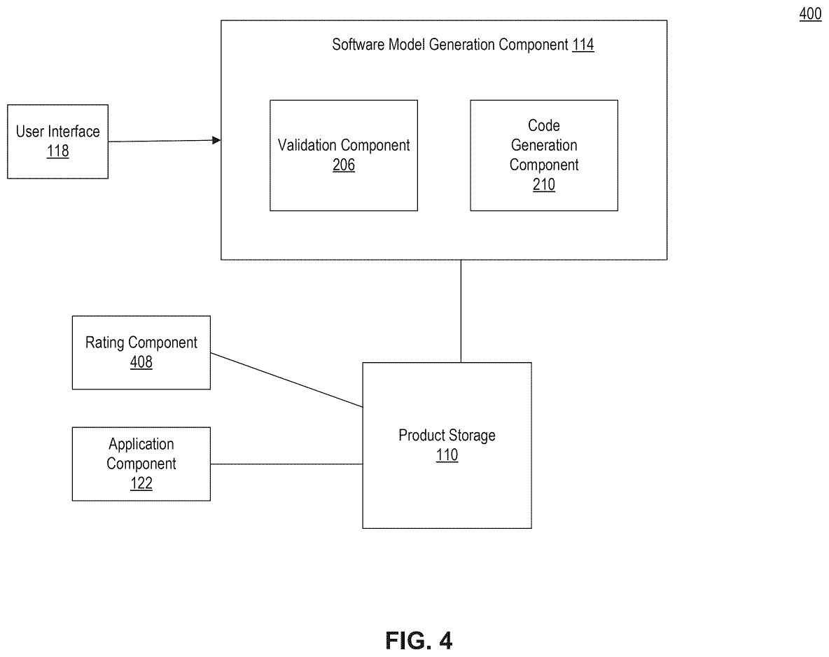

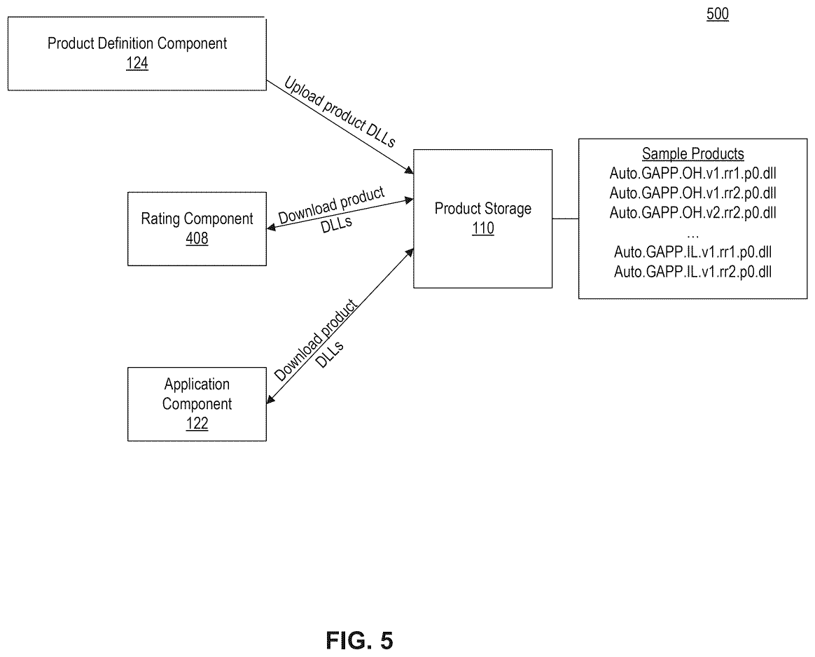

In some embodiments, client device 106 may be used to configure the software product model by providing inputs to product management platform 102. In some embodiments, an application component 122 of product management platform 102 may handle requests from client device 106 as further described in relation with FIGS. 4 and 5. In some embodiments, application component 122 may select and load, to client device 106, a product plugin dynamically based on one or more factors. The factors may include state, LOB, effective date, life cycle, or the like. The product plugin may refer to a code loaded to client device 106 to receive one or more inputs for software product models.

Network 104 may refer to a telecommunications network, such as a wired or wireless network. Network 104 may span and represent a variety of networks and network topologies. For example, network 104 may include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in network 104. Cable, Ethernet, digital subscriber line (DSL), fiber optic lines, fiber to the home (FTTH), and plain old telephone service (POTS) are examples of wired communication that may be included in the network 104. Further, network 104 may traverse a number of topologies and distances. For example, network 104 may include a direct connection, personal area network (PAN), local area network (LAN), metropolitan area network (MAN), wide area network (WAN), or a combination thereof.

As described above, product management platform 102 may fetch data from other sources. In some embodiments, product management platform 102 may fetch data using data retrieval service component 108. Data retrieval service component 108 may be configured to provide data for the product management platform 102 from a plurality of data sources. The plurality of data sources may include external data sources and internal data sources. Accordingly, data retrieval service component 108 may be used by product management platform 102 to connect to external and/or internal systems.

Data retrieval service component 108 may be called by product management platform 102 or client device 106 within environment 100. Data retrieval service component 108 may quickly integrate with a new source of data. Product management platform 102 and/or client device 106) may receive data from data retrieval service component 108 in a specified format (e.g., including data element names, data model structure, etc.) regardless of the source of the data. Data retrieval service component 108 may reconcile data from multiple sources to ensure data consistency and accuracy. Data retrieval service component 108 may provide a caching feature and may use hydration rules defined by product management platform 102 and/or client device 106 to search for data internally before searching to external data sources. Hydration rules may refer to one or more rules that govern the validity and/or integrity of the data. In some embodiments, product management platform 102 may specify how often the data should be pulled from the source and from which source.

In some embodiments, data retrieval service component 108 may receive a request from product management platform 102. The request may include a data source name and a data source product. The request may include a hydration timeframe for each data source and a manual override for each data source. The hydration timeframe may indicate a time period within which the data is considered valid. For example, the request may include “CARFAX®” as the data source name and “vehicle history report” as the data source product. Data retrieval service component 108 may check whether the manual override is enabled (e.g., yes). In response to determining that the manual override is not enabled, data retrieval service component 108 may determine a date associated with the last ordered vehicle history report. If the date satisfies the hydration rules time frames, data retrieval service component 108 may output the stored vehicle history report to product management platform 102. In response to determining that the last ordered vehicle history report does not satisfy the hydration rules time frames, data retrieval service component 108 may output an order for a new vehicle history report to the data source (e.g., CARFAX@).

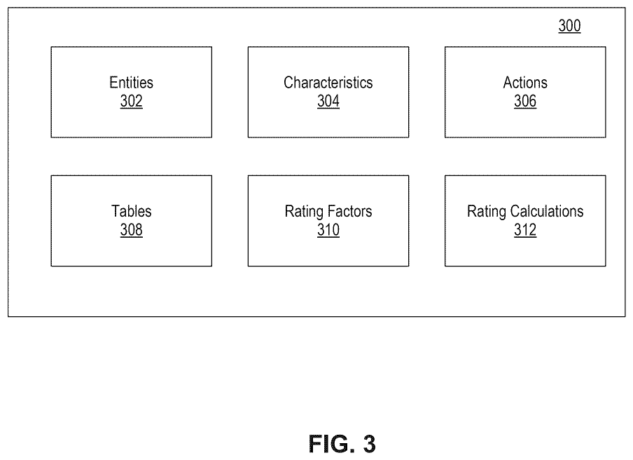

FIG. 2 illustrates a flow diagram 200 for software product model generation and publishing, according to some embodiments. In some embodiments, software model generation component 114 may comprise a model creation component 202, a model configuration component 204, a validation component 206, an approval component 208, a code generation component 210, a promotion component 212, and a publish component 214. Model creation component 202 may be used to create or configure model 116. Model 116 may include model abstractions and model artifacts. Model artifacts may represent lightweight data in an interchange format that may be easy for a human to read and write, and as well as for the computer to parse and generate. The model abstractions may comprise one or more modules that store non-configurable aspects of software product model generation (e.g., DSL expressions that are not configurable). Model artifacts may store data associated with a software product model, such as entities, characteristics, actions, tables, rating factors, and rating calculations. The data may include data files (e.g., comma separated values (CSV) files used in product generation). The model creation component 202 may be used to create or define a software product model, such as shown with respect to FIG. 3.

FIG. 3 illustrates components 300 of a software product model, according to some embodiments. The software product model may be created or defined to include components 300. Components 300 may include entities 302, characteristics 304, actions 306, tables 308, rating factors 310, and rating calculations 312. Entities 302 may refer to a group of characteristics. Characteristics 304 may include raw characteristics and refined characteristics. A characteristic 304 may represent a data value associated with a data element (e.g., an entity of interest to a business operation) associated with the software product model. For example, a characteristic 304 for a software product model associated with a home insurance product may be the year a house was build.

In some embodiments, raw characteristics may represent unprocessed data elements associated with the software product model, such as data received directly from a source. An example of a raw characteristic may be a “date of birth” (e.g., the date of birth of a customer), where the “date of birth” of a customer may be an entity of interest associated with the software product model (e.g., a vehicle insurance). Refined characteristics may be obtained from processing raw characteristics, such as based on a data transformation or refinement. In some embodiments, refined characteristics may be obtained using refinement component 112. For example, if the “date of birth” is Jan. 1, 2000, “age” may be a refined characteristic obtained from the raw characteristic. For example, the refined characteristic “age” may be determined from the raw characteristic “date of birth.”

Actions 306 may be rule-based artifacts that support data API requests and response mapping. Actions 306 may support acquiring data from data sources using data API calls. Actions 306 may use a configurable request and response mapper and builder model. The configurable request and response mapper and builder model may include one or more mapping templates that transform data between data retrieval service component 108 and product management platform 102. The configurable request and response mapper and builder model may build a request mapper to pull the requested data and a response mapper to process the requested data (e.g., a report) once received by the model. In some embodiments, actions 306 may include DSL expressions to connect to data retrieval services (e.g., data retrieval service component 108) to fetch data from external and internal sources (e.g., a vehicle history report). Actions 306 may fetch data based on a change in the state of entities or characteristics when product management platform 102 handles an input request from client device 106 (e.g., pulling a motor vehicle record report when license characteristics of an operator are changed).

Tables 308 may comprise one or more tables that may be used by the data transformations. For example, tables 308 may include a data table that includes data indicating a minimum coverage amount and type of coverage for a plurality of jurisdictions. Data transformations may be utilized to query the data table to determine whether a software product model may be offered in a given jurisdiction and a corresponding minimum coverage amount for a particular type of coverage.

Rating factors 310 may be numerical values that may be used to mutate another characteristic in a mathematical operation. For example, for a software product model for a vehicle insurance product, the rating factors 310 may include driver-related rating factors (e.g., age, gender, driving experience, etc.), vehicle-related factors (e.g., type of the vehicle, model year, etc.), and coverage-related factors (e.g., deductible amount, coverage limits, type of coverage, etc.).

Rating calculations 312 may represent one or more mathematical operations that utilize rating factors 310 to calculate rates for coverages associated with a software product model (e.g., to determine a premium for a customer).

Referring back to flow diagram 200 of FIG. 2, model configuration component 204 may configure artifacts associated with the desired software product model based on the user input and may output the artifacts associated with the software product model to a validation component 206.

Validation component 206 may be configured to validate the artifacts associated with the software product model received from model configuration component 204. For instance, the validation component 206 may validate a structure, format, syntax, etc. of the artifacts. In some embodiments, validation component 206 may connect to a product test system. The product test system may ensure that the software product model (e.g., insurance product) is accurate and up-to-date.

In a non-limiting example, approval component 208 may output the artifacts associated with the software product model to one or more devices associated with an approver (e.g., or may, alternatively, cause a product approval system to which the commit component 208 is connected to output the artifacts). For example, an insurance product may need prior regulatory approval for compliance with statutory provisions. In this example, the approval component 208 or the product approval system) may automatically output the artifacts associated with the software product model to a system associated with an office that provides regulatory approval. In other example, approval component 208 may not be included in flow diagram 200 (e.g., for a software product model that does not require prior approval).

Code generation component 210 may compile the configured (and in some examples approved) software product model to a machine-readable binary runtime asset using code generation components of the product management platform 102. For example, code generation component 210 may process the artifacts and may generate code that is immutable. Code generation component 210 is further described with respect to FIG. 4.

Promotion component 212 may be configured to move the software product models between data stores. In one embodiment, product storage 110 may comprise one or more source blobs and one or more destination blobs. Promotion component 212 may move a software product model from a source blob to a destination blob. In some embodiments, the source and destination blobs may represent non-production and production environments, respectively. Promotion component 212 may output one or more software product models to the publish component 214 based on availability dates. In some embodiments, the availability dates may be associated with each software product model when the software product model is generated. The availability dates may be received as an input from client device 106. The availability date may refer to the period when the software product model is available to customers. For example, the software product model may be generated but may not be available to the customers until a later date.

Promotion component 212 may promote one or more software product models simultaneously. For example, the UI 118 of product management platform 102 may comprise a selection button to select and promote multiple software product models. The process of promoting the one or more software product models may additionally include an option to defer deployment or to prevent deployment during specific times to avoid downtime. The process of process of promoting the one or more software product modes may further include an option to deploy to different environments when generating software product models. In some embodiments, promotion component 212 may request approval from one or more entities (e.g., product management team) before promoting the product. After the software product model is promoted, the software product model may be output to publish component 214. In some cases, product management platform 102 may generate and associate release notes to be associated with the software product model. For example, the release notes may include information about differences between the promoted software product model and a previous version of the software product model. Client devices 106 may receive a notification from promotion component 212 when the product is promoted and is available for selection.

Publish component 214 may publish a promoted software product model for selection by product selection component 216. Product selection component 216 may use a product selection algorithm to identify one or more software product models from product storage 110. Deployed models may be selected for execution using the product selection algorithm. For example, the product selection algorithm may identify what insurance products are available to be quoted. The product selection component 216 may receive a set of query criteria to identify a software product model to be selected by querying product storage 110. The set of query criteria may include a LOB, a state, a product type, etc. The life cycle stage may refer to the type of the transaction, such as new business, renewal, endorsement, or reissue. In some embodiments, the software product models available for customer quotes may be stored in a library in product storage 110. In some embodiments, product selection component 216 may select a latest version of the software product model to ensure compliance regulations, guidelines, etc.

In FIG. 2, components of software model generation component 114 are shown as separate components, this is for illustrative purposes only. In some embodiments, functions of one component may be combined with another component.

FIG. 4 illustrates an environment 400 for code generation, according to some embodiments. In some embodiments, software model generation component 114 may include validation component 206 and code generation component 210. For simplicity, other components of software model generation component 114 are not shown in environment 400. In some embodiments, software model generation component 114 may receive a request to generate the software product model from user interface 118 of product management platform 102.

Based on the generation request, code generation component 210 may create a unique product assembly. In some embodiments, code generation component 210 may generate a source code (e.g., . NET) for the software product model. Code generation component 210 may build the generated source code and upload one or more output DLLs to product storage 110. In some aspects, code generation component 210 may use templates (e.g., 14 templates) to automate the generation of code associated with the software product model. The assembly may be immutable to satisfy one or more criteria such as reusability and increased compliance with state regulations. In one example, code generation component 210 may be implemented using an AZURE® function that hosts a code generator package. ANTLR may be used within code generation component 210 to parse the DSL expressions into code. However, other code generator packages may be used.

Thus, the software product model retrieved from product storage 110 may not change due to its immutability. If it is desired to change a functionality of a software product model, a new software product model with the new functionality may be generated using product management platform 102. In some embodiments, versioning of the software product model may be handled by the naming of the software product model. For instance, each software product model may have its own unique assembly name that may be unique to the specific build. After a software product model has been created, the product assembly may be stored in product storage 110.

Validation component 206 may be configured to validate the artifacts associated with the software product model. In some embodiments, validation component 206 may validate dependencies between data transformations associated with the software product model. Validation component 206 may be configured to validate data files included in the artifacts (e.g., comma separated values (CSV) files used in product generation).

Rating component 408 may handle rating requests as further described in relation with FIG. 5. Application component 122 may handle requests to login to product management platform 102 from client device 106. Application component 122 may also handle requests to pull the available software product models from product storage 110. Although rating component 408 is shown as separate from product management platform 102, it is understood that rating component 408 may be part of product management platform 102.

FIG. 5 illustrates an environment 500 for software product model retrieval, according to some embodiments.

A user may create or change a software product model using product management platform 102. If a request to change a software product model is received, one or more DLLs associated with the software product model may be updated and the updated DLL for the software product model may be stored in product storage 110. For example, if there is a change to an insurance product for the state of Ohio, the DLL associated with the corresponding software product model may be updated and stored in the product storage 110. In some embodiments, the DLL of the software product model associated with the state of Ohio may be generated, uploaded, and stored in product storage 110. In some embodiments, software product models associated with other states are not regenerated. In some embodiments, the DLL may be obtained by compiling the generated code.

Rating component 408 may access product storage 110 and retrieve (e.g., download) one or more software product model dynamic link libraries (DLLs) using an API

In some embodiments, a product definition component 124 may receive an input from a user. In some embodiments, product definition component 124 may receive the input via the user interface 118. The input may indicate a change to the software product model. For example, the input may indicate a change in a rating factor of a software product model. Code generation component 210 may retrieve a product definition from model 116. Code generation component was previously described with reference to FIG. 4.

Rating component 408 may invoke one or more functions to obtain (e.g., download) DLLs of one or more software product models from product storage 110. Rating component 408 may instantiate each of the one or more software product models. In some embodiments, rating component 408 may store the instantiated copy of the software product model in a memory associated with rating component 408. Rating component 408 may receive a rating request. The rating request may include a product identifier. The rating request may be to revise one or more rating factors associated with the software product model. Rating component 408 may select an instance of the software product model based on the rating request.

In some embodiments, rating component 408 may determine whether a software product model instance is available in the memory. In response to determining that the software product model instance is not available in the memory, rating component 408 may retrieve the software product model DLL associated with the request from product storage 110. In one example, rating component 408 may invoke a package manager to retrieve the software product model. In accordance with a non-limiting example, rating component 408 may invoke NUGET@ to retrieve the software product model DLL associated with the rating request from product storage 110. Then, an instance of the software product model may be added to the memory associated with the rating component 408. Rating component 408 may process the rating request. This on-demand or lazy-loading may be helpful to rating component 408 when the rating component 408 is expected to serve requests associated with a software product model for which a newer version was uploaded after rating component 408 is initialized.

In some embodiments, application component 122 may handle requests to login to product management platform 102 from client device 106. Application component 122 may also handle requests to pull the available software product models from product storage 110. In some embodiment, application component 122 may retrieve product DLLs from product storage 110.

### Methods of Operation

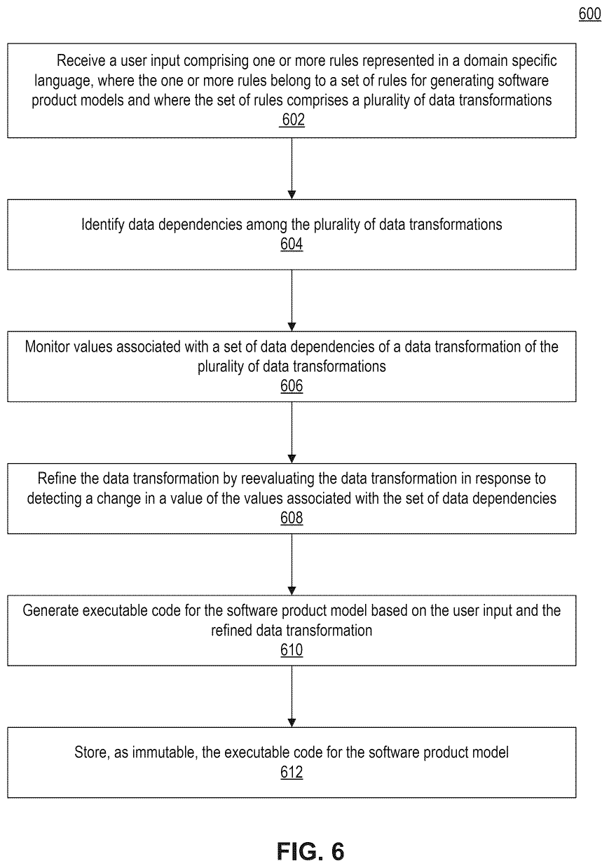

FIG. 6 illustrates a flowchart for an example method 600 for generating a software product model, according to some embodiments. As a convenience and not a limitation, FIG. 6 may be described with regard to elements of FIGS. 1-5. Method 600 may represent an operation of a computing system for generating a software product model. But method 600 is not limited to the specific aspects depicted in those figures and other systems may be used to perform the method as will be understood by those skilled in the art. It is to be appreciated that not all operations may be needed, and the operations may not be performed in the same order as shown in FIG. 6.

In 602, product management platform 102 may receive a user input from client device 106. The user input may comprise one or more rules represented in DSL. The one or more rules may belong to a set of rules used for generating software product models. The one or more rules may comprise a plurality of data transformations.

In 604, product management platform 102 may identify data dependencies among the plurality of data transformations. Data dependencies between data transformations may refer to when an output of a data transformation is used as an input for a subsequent data transformation. Product management platform 102 may identify the data dependencies by parsing the data transformation to identify common variable names or function calls in data transformations.

In 606, product management platform 102 may monitor values associated with a set of data dependencies of a data transformation of the plurality of data transformations. In some embodiments, product management platform 102 may associate an event listener with (e.g., attach an event listener to) each data transformation of the plurality of data transformations. The event listener may detect a change in values of data dependencies. In some embodiments, a value of the data dependency may correspond to a raw characteristic associated with the data transformation. For example, if a data transformation involves a rate calculation based on a minimum coverage amount as required by a state regulation, the event listener may detect a change in the minimum coverage amount (e.g., monitor a source of the regulation for the state).

In 608, product management platform 102 may refine the data transformation by reevaluating the data transformation in response to detecting a change in a value of the values associated with the set of data dependencies. In some embodiments, based on the event listener detecting the change, an event handler may execute a code to reevaluate the data transformation. In some embodiments, product management platform 102 may determine an order of refinement for the plurality of data transformations based on a quantity of dependencies associated with each data transformation of the plurality of data transformations. Then, product management platform 102 may refine the plurality of data transformations in accordance with the order of refinement. For example, product management platform 102 may process the data transformations that involve the lowest quantity of dependencies first.

In some embodiments, the data transformation may operate on a data table (e.g., a table query). Product management platform 102 may identify one or more data columns of the data table used by the data transformation. Product management platform 102 may load the one or more data columns to a memory (e.g., main memory 708), without loading other columns from the data table into memory. Then, product management platform 102 may process the data transformation.

In some embodiments, product management platform 102 may analyze the data transformations and may process the data table based on a type (e.g., category) of the data transformation. For example, product management platform 102 may determine a type of a table query (e.g., one to one match). Based on the type, product management platform 102 may hash data elements of the data table. For example, product management platform 102 may hash data elements that satisfy the data transformations. Product management platform 102 may store the result of the hash in the memory and process the data transformation based on the stored results.

In 610, product management platform 102 may generate executable code for the software product model based on the user input and the refined data transformation.

In 612, product management platform 102 may store, as immutable, the executable code for the software product model. For example, product management platform 102 may store, as immutable, the executable code in product storage 110.

FIG. 7 illustrates an example computer system 700 for implementing various embodiments. Various embodiments may be implemented, for example, using one or more well-known computer systems, such as computer system 700. For example, product management platform 102 may be implemented using combinations or sub-combinations of computer system 700. Additionally or alternatively, client device 106, and data retrieval service component 108 may be implemented using combinations or sub-combinations of computer system 700. Additionally or alternatively, one or more computer systems 700 may be used, for example, to implement any of the embodiments discussed herein, as well as combinations and sub-combinations thereof.

Computer system 700 may include one or more processors (also called CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities, or other approaches for allowing computer programs and/or other instructions and/or data to be accessed by computer system 700. Such means, devices, components, instrumentalities, or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including, but not limited to, remote or distributed cloud computing solutions; local or on-premises software (“on-premise” cloud-based solutions); “as a service” models (e.g., content as a service (CaaS), digital content as a service (DCaaS), software as a service (Saas), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including, but not limited to, JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700 or processor(s) 704), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments may operate with software, hardware, and/or operating system implementations other than those described herein.

It is to be appreciated that the Detailed Description section, and not any other section, is intended to be used to interpret the claims. Other sections may set forth one or more, but not all, exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries may be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment might not necessarily include the particular feature, structure, or characteristic. Moreover, such phrases may not necessarily refer to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

1. A computer-implemented method for generating a software product model, comprising:
receiving, by one or more processors, a user input comprising one or more rules represented in a domain specific language, wherein the one or more rules belong to a set of rules for generating software product models, wherein the set of rules comprises a plurality of data transformations;
identifying data dependencies among the plurality of data transformations;
monitoring values associated with a set of data dependencies of a data transformation of the plurality of data transformations;
in response to detecting a change in a value of the values associated with the set of data dependencies, refining the data transformation by reevaluating the data transformation;
generating executable code for the software product model based on the user input and the refined data transformation; and
storing, as immutable, the executable code for the software product model.

2. The computer-implemented method of claim 1, wherein monitoring the values associated with the data dependencies of the data transformation of the plurality of data transformations further comprises:
associating an event listener with each data transformation of the plurality of data transformations.

3. The computer-implemented method of claim 1, further comprising:
determining an order of refinement for the plurality of data transformations based on a quantity of dependencies associated with each data transformation of the plurality of data transformations; and
refining the plurality of data transformations in accordance with the order of refinement.

4. The computer-implemented method of claim 1, further comprising:
identifying one or more data columns of a data table used by the data transformation;
loading the one or more data columns to a memory; and
processing the data transformation.

5. The computer-implemented method of claim 4, further comprising:
hashing one or more data elements of the data table based on a category of the data transformation; and
storing the hash value in the memory.

6. The computer-implemented method of claim 1, further comprising:
generating a model comprising the one or more rules represented in the domain specific language.

7. The computer-implemented method of claim 1, wherein the software product model is an insurance product.

8. A computing system for generating a software product model, comprising:
one or more memories, and
at least one processor each coupled to at least one of the memories and configured to perform operations comprising:
receiving a user input comprising one or more rules represented in a domain specific language, wherein the one or more rules belong to a set of rules for generating software product models, wherein the set of rules comprises a plurality of data transformations;
identifying data dependencies among the plurality of data transformations;
monitoring values associated with a set of data dependencies of a data transformation of the plurality of data transformations;
in response to detecting a change in a value of the values associated with the set of data dependencies, refining the data transformation by reevaluating the data transformation;
generating executable code for the software product model based on the user input and the refined data transformation, and
storing, as immutable, the executable code for the software product model.

9. The computing system of claim 8, wherein the operations further comprise:
associating an event listener with each data transformation of the plurality of data transformations.

10. The computing system of claim 8, wherein the operations further comprise:
determining an order of refinement for the plurality of data transformations based on a quantity of dependencies associated with each data transformation of the plurality of data transformations; and
refining the plurality of data transformations in accordance with the order of refinement.

11. The computing system of claim 8, wherein the operations further comprise:
identifying one or more data columns of a data table used by the data transformation;
loading the one or more data columns to a memory; and
processing the data transformation.

12. The computer system of claim 11, wherein the operations further comprise: :
hashing one or more data elements of the data table based on a category of the data transformation; and
storing the hash value in the memory.

13. The computing system of claim 8, wherein the operations further comprise:
generating a model comprising the one or more rules represented in the domain specific language.

14. A non-transitory computer-readable medium having instructions stored thereon that, when executed by at least one computing device, cause the at least one computing device to perform operations comprising:
receiving a user input comprising one or more rules represented in a domain specific language, wherein the one or more rules belong to a set of rules for generating software product models, wherein the set of rules comprises a plurality of data transformations;
identifying data dependencies among the plurality of data transformations;
monitoring values associated with a set of data dependencies of a data transformation of the plurality of data transformations;
in response to detecting a change in a value of the values associated with the set of data dependencies, refining the data transformation by reevaluating the data transformation;
generating executable code for the software product model based on the user input and the refined data transformation; and
storing, as immutable, the executable code for the software product model.

15. The non-transitory computer-readable medium of claim 14, wherein monitoring the values associated with the data dependencies of the data transformation of the plurality of data transformations further comprises:
associating an event listener with each data transformation of the plurality of data transformations.

16. The non-transitory computer-readable medium of claim 14, wherein the operations further comprise:
determining an order of refinement for the plurality of data transformations based on a quantity of dependencies associated with each data transformation of the plurality of data transformations; and
refining the plurality of data transformations in accordance with the order of refinement.

17. The non-transitory computer-readable medium of claim 14, wherein the operations further comprise:
identifying one or more data columns of a data table used by the data transformation;
loading the one or more data columns to a memory; and
processing the data transformation.

18. The non-transitory computer-readable medium of claim 17, wherein the operations further comprise:
hashing one or more data elements of the data table based on a category of the data transformation, and
storing the hash value in the memory.

19. The non-transitory computer-readable medium of claim 14, wherein the operations further comprise:
generating a model comprising the one or more rules represented in the domain specific language.

20. The non-transitory computer-readable medium of claim 14, wherein the software product model is an insurance product.
